(19) United States
(12) Patent Application Publication
(10) Pub. No.: US 2011/0208885 A1
(43) Pub. Date: Aug. 25, 2011

(54) DATA BUS CONTROL METHOD AND APPARATUS

(75) Inventors: Robin Shih Cheang KWEK, Singapore (SG); Shuang ZHANG, Singapore (SG)

(73) Assignees: Panasonic Corporation, Osaka (JP); Panasonic Semiconductor Asia Pte., Ltd., Singapore (SG)

(21) Appl. No.: 12/712,403

(22) Filed: Feb. 25, 2010

(51) Int. Cl. G06F 13/00; G06F 1/04

(52) U.S. Cl. 710/107; 713/600

(57) ABSTRACT

A method and apparatus to prevent I2C device from hanging the I2C data bus and thus stopping other devices in the system from transmitting or receiving data is presented. A logic transition detector detects a logic transition at the output data line of an I2C device and triggers a timer. The timer starts counting after it is triggered. A reset module resets the I2C interface module in the I2C device after the timer counts to a specified period of time. The timer is reset when the logic transition detector detects another logic transition at the output data line of the I2C device.

### BACKGROUND OF THE INVENTION

The present invention relates to a data bus control method and an apparatus thereof which are for preventing a slave device from indefinitely holding the Inter-Integrated Circuit (I2C) data bus unintentionally and thus stopping other devices in the I2C bus system from transmitting or receiving data. This condition is typically referred to as a hang condition.

I2C bus is one of the most widely used communication protocol for communicating between devices in electronics systems. FIG. 1A shows a block diagram of a conventional I2C system. For simplicity, in FIG. 1A, four I2C devices are shown. However, in actual applications, there may be multiple I2C devices connected to the I2C bus 103. The I2C bus 103 requires two bi-directional bus lines, a serial clock line 101 and a serial data line 102. Collectively, both the serial clock line 101 and the serial data line 102 are referred to as I2C bus 103. Each device connected to the bus is recognized by a unique address. The devices can be considered as masters or slaves when performing data transfers. A master is the device which initiates a data transfer on the bus and generates the clock signals to permit that transfer. At that time, any device addressed is considered a slave. A master device will ensure that the I2C bus 103 is available for data transfer (both serial clock line 101 and serial data line 102 are at logic HIGH) before transferring data. No clock or data will be issued by the master device if the I2C bus 103 are busy (either one of the serial clock line 101 or serial data line 102 are at logic LOW). A slave device will not transfer any data when it does not receive the clock issued by the master device. FIG. 1B shows a general configuration of an I2C device provided in the I2C system. Both the serial clock line 101 and serial data line 102 are pulled to logic HIGH by the pull-up resistors 113A and 113B when they are not occupied by any of the I2C devices in the system. An I2C device can control both the serial clock line 101 and serial data line 102 with the control circuits 114A and 114B. The control circuit 114A includes a buffer 121, an inverter 122 and a NMOS 123, where the inverter 122 and the NMOS 123 are collectively referred to as a pull-down circuit 124. When output clock line 115 is set to logic LOW, the inverter 122 and the NMOS 123 will pull the serial clock line 101 to logic LOW. When node 115 is set to logic HIGH, serial clock line 101 will be released and pulled back to logic HIGH by the pull-up resistors 113A.

In a similar fashion, the serial data line 102 can also be controlled by the output data line 116 with the control circuit 114B and pull-up resistor 113B. Control circuit 114B has the same structure as the control circuit 114A.

FIG. 2 shows the waveforms of a conventional I2C data transfer. The waveforms show the signal of serial clock line 101 and serial data line 102 in FIG. 1A. First, a master device initiates a transfer, either for reading or writing by issuing a START command 201. Then, the master device sends the address of the designated slave device 202. The designated slave device will issue an ACKNOWLEDGE signal after receiving the slave address sent by the master device 203. The master device will continue to transmit the next byte (8-bits long) of data after receiving the ACKNOWLEDGE signal; the slave device will issue an ACKNOWLEDGE signal every time it receives a byte of data sent by the master device 204. The transmission will end when the master device issues a STOP command 205.

FIG. 3 shows the waveforms on the circumstances that lead to the hanging of the I2C bus. The waveforms show the signal of serial clock line 101 and serial data line 102 in FIG. 1A. A master device initiates a transfer after ensuring that the I2C buses 101 and 102 are free and that the designated slave device issues an ACKNOWLEDGE signal after it received a byte of data from the master device as explained in FIG. 2.

A problem is encountered when the I2C interface of the slave device fails to function properly in the middle of the data transfer such that the slave device pulls the serial data line 102 to logic LOW 301. The master device discontinues the data transfer (stop issuing clock and data) upon detection of a logic LOW 302 at the serial data line 102. The slave device will stop transferring or receiving data as the serial clock is stopped. As a result, the serial data line 102 will remain stuck at logic LOW, thus hanging the I2C bus.

The common method to recover from the I2C bus hang for a conventional I2C control is to reset the affected device or to shut down the entire system. Unfortunately, some of the I2C devices may not have a dedicated reset input to reset the affected device. Furthermore, shutting down the entire system may affect the other non-I2C devices in the system.

Therefore, there is a need for a method to clear the hanging I2C bus without the need for a dedicated reset input in the I2C devices or to shut down the entire system.

### SUMMARY OF THE INVENTION

The purpose of this invention is to provide a method to detect a hang in the I2C bus and clear the hang by resetting the affected I2C device. Unlike the conventional I2C system, this invention does not need a dedicated reset input or to shut down the entire system to clear the hanging I2C bus.

This invention has the capability to detect an I2C bus hang causing by the control logic in an I2C device and reset the I2C interface module in the affected I2C device to clear the hanging I2C bus.

### BRIEF DESCRIPTION OF THE DRAWINGS

FIG. 1A is a block diagram showing the conventional I2C systems;

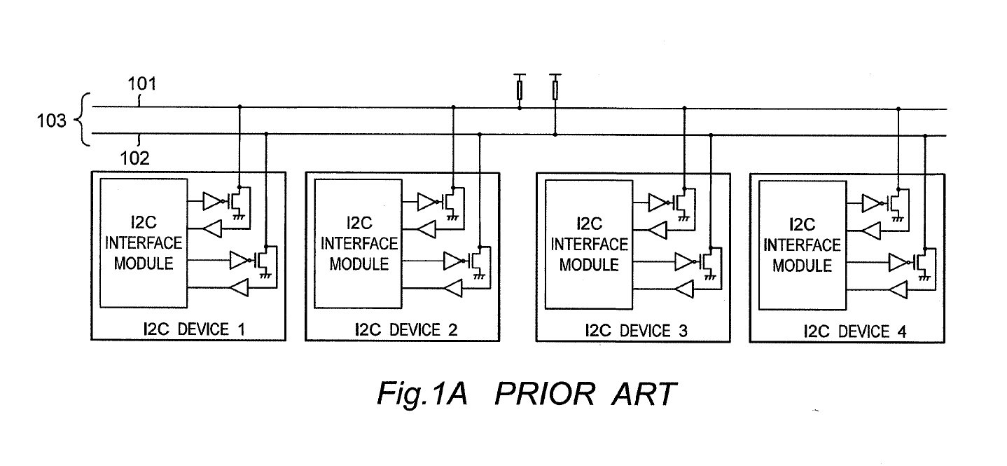

FIG. 1B is a block diagram showing the conventional I2C device;

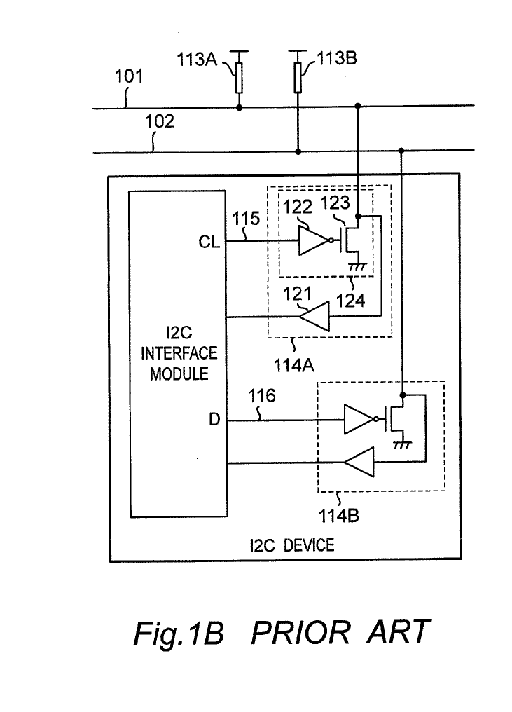

FIG. 2 is a waveform showing the conventional I2C data transfer;

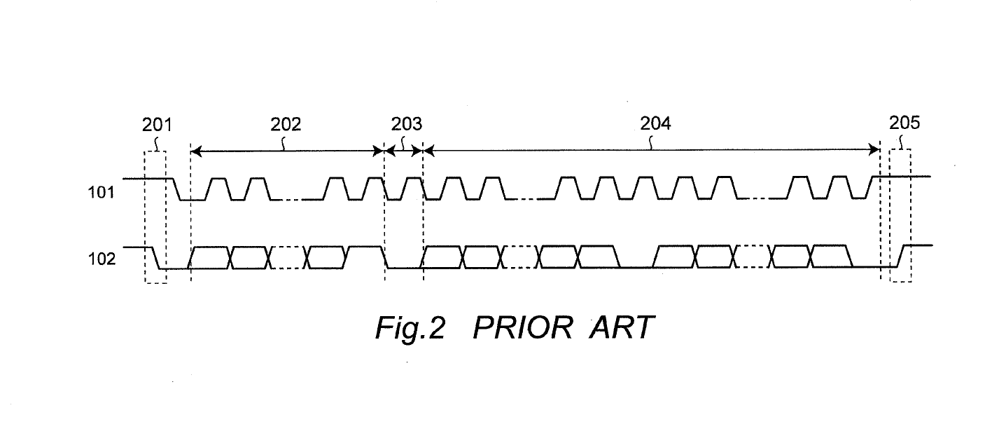

FIG. 3 is a waveform showing the circumstances that lead to the hanging of the I2C bus;

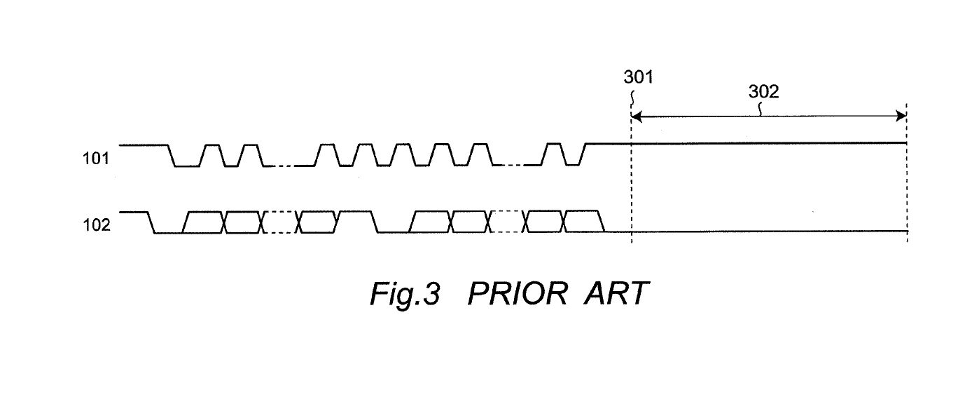

FIG. 4 is a system block diagram of a system which detects and clears a hang at the I2C bus in accordance to the present invention;

FIG. 5A is a schematic block diagram of a system which detects and clears a hang at the serial data line in accordance to the present invention;

FIG. 5B is a schematic block diagram of a system which detect and clear a hang at the serial clock line in accordance to the present invention;

FIG. 6A is a waveform showing a method to clear the hanging in the serial data line in accordance to the present invention; and

FIG. 6B is a waveform showing a method to clear the hanging in the serial clock line in accordance to the present invention.

### DETAILED DESCRIPTION OF THE PREFERRED EMBODIMENTS

### First Embodiment

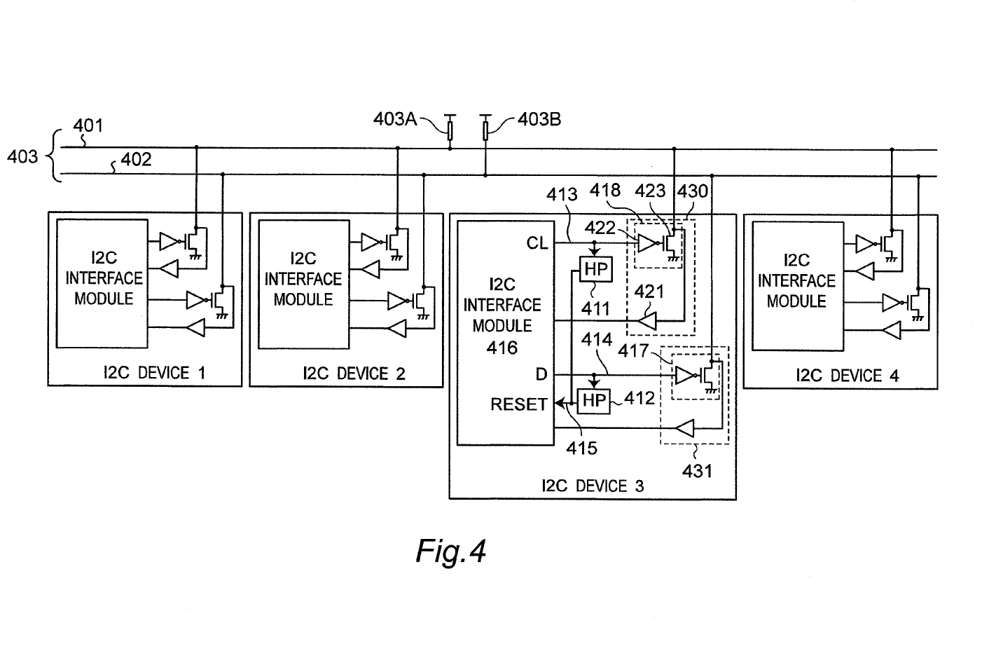

The first preferred embodiment based on the present invention, is shown in FIG. 4.

Referring to FIG. 4, an Inter-Integrated Circuit (I2C) system has a plurality of, such as four as an example, I2C devices. Four I2C devices are connected to I2C bus 403. The I2C bus 403 requires two bi-directional bus lines, a serial clock line 401 and a serial data line 402. Collectively, both the serial clock line 401 and the serial data line 402 are referred to as I2C bus 403. Each I2C device connected to the bus has an I2C interface module 416 and is recognized by a unique address. The I2C interface module 416 has a clock output CL connected with an output clock line 413, a data output D connected with an output data line 414 and a reset input RESET connected with a reset line 415.

Each of the I2C devices can be considered as a master terminal or a slave terminal when performing data transfer or transmission. A master terminal is the device which initiates a data transmission on the bus and generates the clock signals to permit that transmission. At that time, any device addressed is considered a slave terminal. A master terminal will ensure that the I2C bus 403 is available for data transmission (both serial clock line 401 and serial data line 402 are at logic HIGH) before transmitting data. No clock or data will be issued by the master terminal if the I2C bus 403 are busy (either one of the serial clock line 401 or serial data line 402 are at logic LOW). A slave terminal will not transmit any data when it does not receive the clock issued by the master terminal. The master terminal and the slave terminal are generally referred to as a terminal.

An I2C device 3 provided in the I2C system is connected to a serial clock line 401 and serial data line 402, which are pulled to logic HIGH by the pull-up resistors 403A and 403B when they are not occupied by any of the I2C devices in the system. An I2C device can control both the serial clock line 401 and serial data line 402 with control circuits 430 and 431. The control circuit 430 includes a buffer 421, an inverter 422 and a NMOS 423, where the inverter 422 and the NMOS 423 are collectively referred to as a pull-down circuit 418. When output clock line 413 from the I2C interface module 416 is set to logic LOW, the inverter 422 and the NMOS 423 will pull the serial clock line 401 to logic LOW. When node 413 is set to logic HIGH, serial clock line 401 will be released and pulled back to logic HIGH by the pull-up resistors 403A.

In a similar fashion, the serial data line 402 can also be controlled by the output data line 414 with the control circuit 431 and pull-up resistor 403B. Control circuit 431 has the same structure as the control circuit 430.

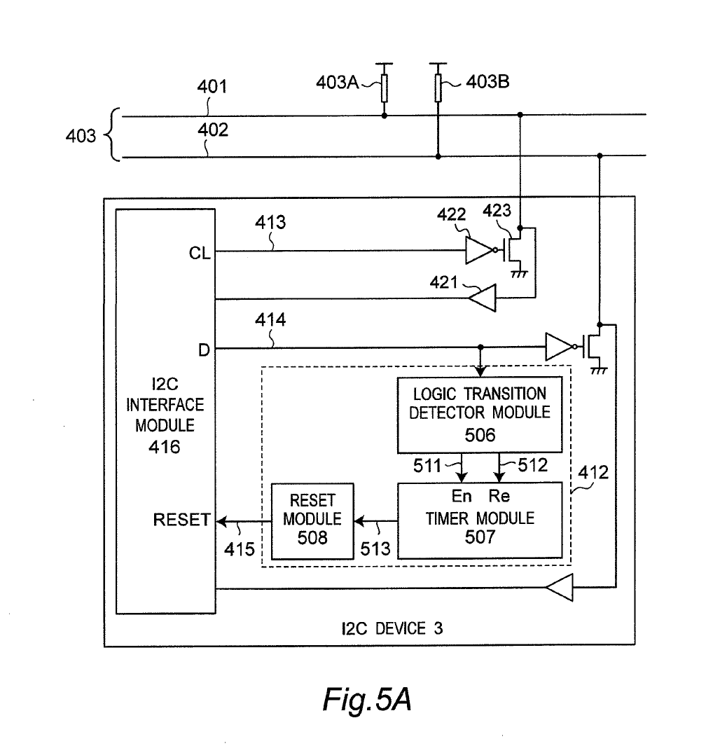

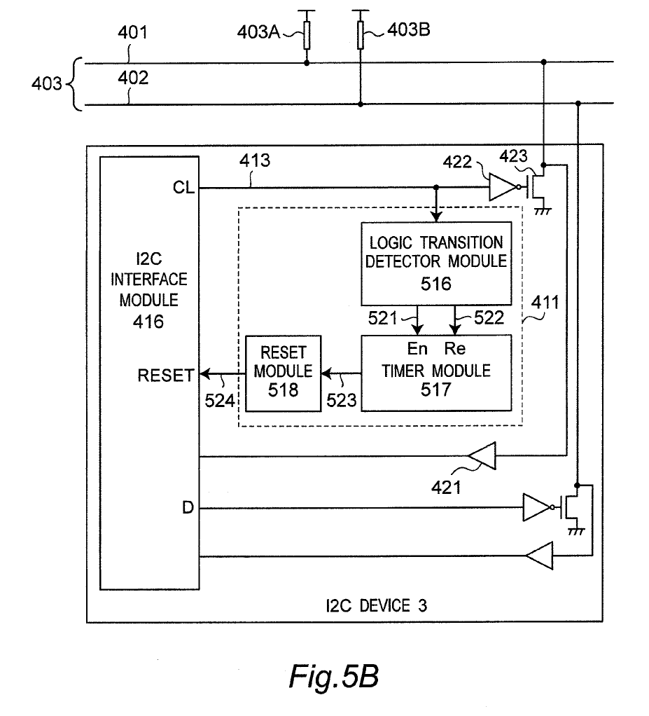

An I2C device 3 is implemented with hang prevention modules 411 and 412 which are provided for preventing the indefinite hanging of the I2C bus under abnormal conditions. Hang prevention module 411 monitors the clock signal on output clock line 413 and is used to clear the hanging at serial clock line 401, while hang prevention module 412 monitors the data signal on output data line 414 and is used to clear the hanging at serial data line 402. The input of hang prevention module 411 is connected to the output clock line 413 and the input of hang prevention module 412 is connected to the output data line 414. The outputs of both hang prevention modules 411 and 412 are connected to the reset input line 415 of the I2C interface module 416. The hang prevention module 411 can be arranged such as shown in FIG. 5B, and the hang prevention module 412 can be arranged such as shown in FIG. 5A. Any other arrangement can be used.

Under normal operating conditions, the serial data line 402 is pulled to logic HIGH by the pull-up resistor 403B. When the I2C interface module 416 outputs a logic LOW to output data line 414, the serial data line 402 will be pulled to logic LOW by the pull-down circuit 417. On the other hand, when the I2C interface module 416 output a logic HIGH to output data line 414, the serial data line 402 will be released and pull back to logic HIGH by the pull-up resistor 403B. The same operation applies for the serial clock line 401, which is pulled to logic LOW by pull-down circuit 418 when output clock line 413 is at logic LOW, and pulled to logic HIGH by pull-up resistor 403A when output clock line 413 is at logic HIGH. The pull-down circuits 417 and 418 are generally referred to as pulling circuits for pulling the bus lines to a predetermined level. The pulling circuit 417, 418 pulls the data bus to a predetermined level relatively to the clock signal or to the data signal.

Under normal operating conditions, I2C device will not pull the serial clock line 401 or the serial data line 402 to logic LOW for a period longer than a predetermined period of time. In accordance to present invention, if an I2C device is pulling either one of the line 401 or 402 to logic LOW for a time longer than a predetermined period of time, the I2C interface module 416 receives a reset signal from hang prevention module 411 or 412 to its RESET input, whereupon the I2C interface module 416 will be reset in order to release the line 401 or 402 which the I2C device occupied. Such a predetermined time is a time which is longer than any duration time of logic LOW or HIGH that will be produced from the clock output CL or from the data output D when the I2C interface module 416 is operating properly.

Since the reset signal is produced when the I2C interface module 416 is producing, at least from one of the clock output CL and data output D, a logic LOW for a period of time which is not expected to happen according to the designed system arrangement of the I2C interface module 416, it is determined that the I2C interface module 416 is operating not properly. In this case, by the use of the reset signal applied to the RESET input, the system in the I2C interface module 416 is automatically reset. Thus, the date transfer will be temporarily terminated, and will be restarted by a self recovering system provided in the I2C interface module 416.

### Second Embodiment

The second preferred embodiment based on the present invention, is as shown in FIG. 5A.

Referring to FIG. 5A, a schematic block diagram is showing a system for clearing a hang in the serial data line in accordance to the present invention.

In the I2C bus communication, the device which initiates a data transfer on the I2C bus 403 and generates the clock signals to permit that transfer is referred as master while any device responding to the transfer is considered a slave. In an embodiment, any of the I2C devices can act as a master or slave device. The present invention can be implemented in both master and slave. For simplicity in the drawing FIG. 5A, only one I2C device is used for explanation of the present invention.

The embodiment illustrated in FIG. 5A includes an I2C device 3 in communication over a serial clock line 401 and a serial data line 402 in an I2C system bus 403, a logic transition detector module 506, a timer module 507 and a reset module 508. The logic transition detector module 506, the timer module 507 and the reset module 508, taken together, correspond to the hang prevention module 412. Timer module 507 counts time, and reset module 508 compares the counted time with a predetermined time. Such a predetermined time is a time which is longer than any duration time of logic LOW or HIGH that will be produced from the data output D when the I2C interface module 416 is operating properly.

The functional units labeled as modules can be realized by software programming, logic gates, transistors, programmable logic devices, or other discrete components. Software programming of the modules is achieved via programming of a microcontroller or a central processing unit (CPU). Logic gates implementation of the modules is realized by using logic gates to form a digital circuitry to perform the desired function. Alternatively, programmable logic devices may be appropriately designed to satisfy the required function criteria. Yet another way to realize these modules would be using analog circuitry implemented using integrated circuits or discrete components.

The logic transition detector module 506 detects logic level transition from HIGH to LOW or LOW to HIGH of the output data line 414 from the I2C interface module 416. The logic transition detector module 506 has one input which is connected to the output data line 414 and two outputs which are connected to the timer module 507. Output node 511 is the enable signal, produced upon detection of logic LOW on the output data line 414, to the timer module 507 while output node 512 is the reset signal, produced upon detection of logic HIGH on the output data line 414, to the timer module 507.

The timer module 507 is used to count the period of time when the output data line 414 is held at logic LOW. The timer module 507 starts counting when it is enabled by the enable signal from output node 511. On the contrary, the timer module 507 stops counting and resets to its default or initial value when it is reset by the reset signal from output node 512. The timer module 507 outputs a timer count to the reset module 508 via output node 513.

The reset module 508 compares the time count from output node 513 with the predetermined time and generates a reset pulse to reset the I2C interface module 416 via output node 415 when the timer count from output node 513 exceeds the predetermined time.

The I2C interface module 416 controls the I2C data transfer for the I2C device. Once the I2C interface module 416 is reset, the output data line 414 will be set to logic HIGH.

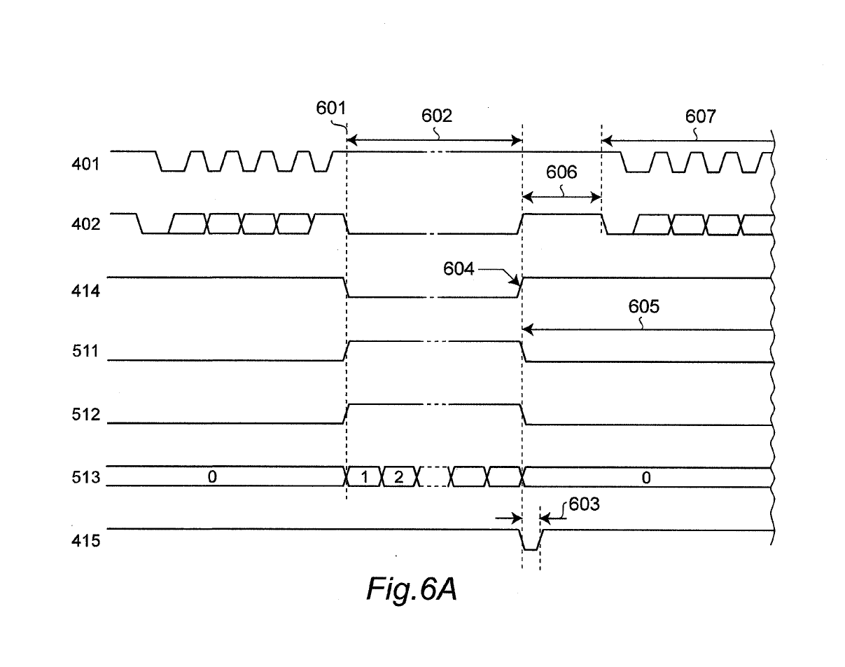

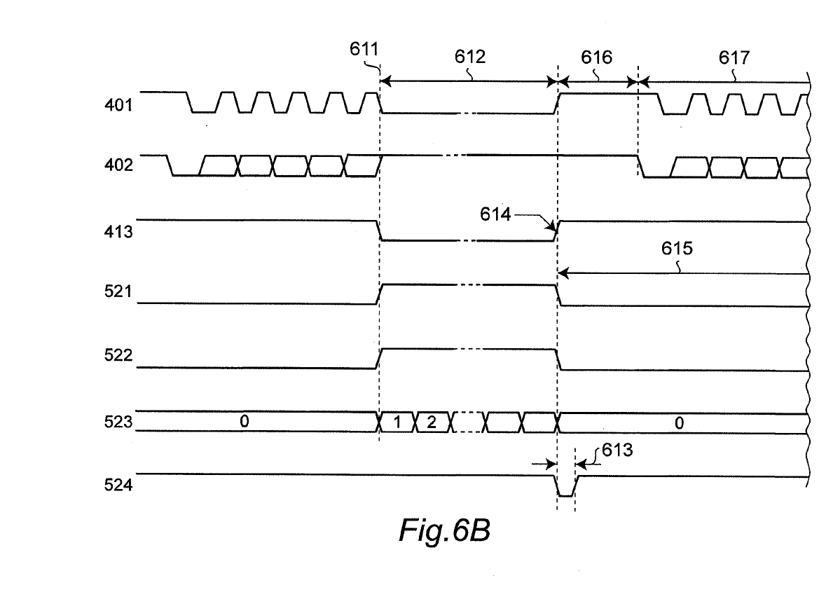

Referring to FIG. 6A, exemplary waveform diagrams are shown, explaining the method of operation of the second embodiment of the present invention. The description of the method refers to elements of FIG. 5A, like numbers referring to like elements.

The method starts when the logic transition detector 506 detects a transition from logic HIGH to logic LOW (at time 601) at the output data line 414. The timer will be triggered by the enable signal and starts counting a period of time 602. The reset module 508 compares the time count from the timer 507 and generates a reset pulse 603 to reset the I2C interface module 416 when the time count exceeds the predetermined period of time. After the I2C interface module 416 is reset, the output data line 414 is set to logic HIGH at instance 604. The logic transition detector module 506 generates a reset signal 605 to reset the timer 507 once it detects a logic LOW to logic HIGH transition at the output data line 414. The serial data line 402 is pulled back to logic HIGH by the pull-up resistor 403B (at a time period 606). A master device can initiate a new transfer afterwards (at time period 607).

### Third Embodiment

The third preferred embodiment based on the present invention, is as shown in FIG. 5B.

Referring to FIG. 5B, similar to the second embodiment of FIG. 5A, for the serial clock line 401, the above operation applies, with logic transition detector module 516 coupled to the output clock line 413, and its output nodes 521 and 522 coupled to timer module 517. Timer module 517 in turn outputs the timer count to the reset module 518 via output node 523. Again, reset module 518 generates a reset pulse to the I2C interface module 416 via output node 524 when the timer count from output node 523 exceeds the predetermined time.

Referring to FIG. 6B, exemplary waveform diagrams are shown, explaining the method of operation of the third embodiment of the present invention. The description of the method refers to elements of FIG. 5B, like numbers referring to like elements.

The method starts when the logic transition detector detects a transition from logic HIGH to logic LOW (at time 611) at the output clock line 413. The timer will be triggered by the enable signal and starts counting for a period of time 612. The reset module 518 compares the time count from the timer 517 and generates a reset pulse 613 to reset the I2C interface module 416 when the time count exceeds the predetermined period of time. After the I2C interface module 416 is reset, the output clock line 413 is set to logic HIGH at instance 614. The logic transition detector module 516 generates a reset signal 615 to reset the timer 517 once it detects a logic LOW to logic HIGH transition at the output clock line 413. The serial clock line 402 is pulled back to logic HIGH by the pull-up resistor 403B (at a time period 616). A master device can initiate a new transfer afterwards (at time period 617).

This invention is implemented within the I2C device; therefore no additional circuitries are needed in the I2C system. With this invention, the I2C device does not need to have a dedicated reset input or shut down the entire system in order to clear the hanging I2C bus.

Having described the above embodiment of the invention, various alternations, modifications or improvement could be made by those skilled in the art. Such alternations, modifications or improvement are intended to be within the spirit and scope of this invention. The above description is by ways of example only, and is not intended as limiting. The invention is only limited as defined in the following claims.

What is claimed is:

1. An apparatus to prevent an I2C device from hanging the I2C system bus, the apparatus comprising:
a hang prevention module coupled to the pull down circuit and the I2C interface module of the I2C device.

2. The apparatus according to claim 1, wherein the said hang prevention module comprises:
a logic transition detector module to detect the logic transition of the output data line of an I2C device;
a timer module to count to a specific period of time;
a reset module to reset the I2C interface of an I2C device in response to the completion of the said timer module counting to the specified period of time.

3. The apparatus according to claim 2, wherein said logic transition detector module is implemented via software programming of a microcontroller or a central processing unit.

4. The apparatus according to claim 2, wherein said logic transition detector module is implemented via a digital circuitry using logic gates.

5. The apparatus according to claim 2, wherein said logic transition detector module is implemented via programmable logic devices.

6. The apparatus according to claim 2, wherein said logic transition detector module is realized via analog circuitry implemented using integrated circuits or discrete components.

7. The apparatus according to claim 2, wherein said timer module is implemented via software programming of a microcontroller or a central processing unit.

8. The apparatus according to claim 2, wherein said timer module is implemented via a digital circuitry using logic gates.

9. The apparatus according to claim 2, wherein said timer module is implemented via programmable logic devices.

10. The apparatus according to claim 2, wherein said timer module is realized via analog circuitry implemented using integrated circuits or discrete components.

11. The apparatus according to claim 2, wherein said reset module is implemented via software programming of a microcontroller or a central processing unit.

12. The apparatus according to claim 2, wherein said reset module is implemented via a digital circuitry using logic gates.

13. The apparatus according to claim 2, wherein said reset module is implemented via programmable logic devices.

14. The apparatus according to claim 2, wherein said reset module is realized via analog circuitry implemented using integrated circuits or discrete components.

15. A method to prevent an I2C device from hanging the I2C system bus, the method comprising steps of:
enabling a timer when a first logic transition at the output data line of the said I2C device is detected;
resetting the I2C module of the said I2C device after the said timer counts to a specified period of time;
resetting said timer when a second logic transition at the output data line of an I2C device is detected.

16. The method according to claim 15, wherein said first logic transition is a logic HIGH to logic LOW transition.

17. The method according to claim 15, wherein said second logic transition is a logic LOW to logic HIGH transition.

18. A data bus control apparatus for controlling data transmission from, or data receiving to, one terminal connected to a data bus, said terminal having a data bus control apparatus comprising:
an I2C interface module having a clock output for producing a clock signal and a reset input for receiving a reset signal;
a pulling circuit for pulling the data bus to a predetermined level relatively to the clock signal; and
a hang prevention module for monitoring the clock signal such that when the clock signal holds a logic LOW or HIGH for a time longer that a predetermined time a reset signal is produced which is applied to said reset input, whereby the producing of clock signal by the I2C interface module is reset.

19. A data bus control apparatus for controlling data transmission from, or data receiving to, one terminal connected to a data bus, said terminal having a data bus control apparatus comprising:
an I2C interface module having a data output for producing a data signal and a reset input for receiving a reset signal;
a pulling circuit for pulling the data bus to a predetermined level relatively to the data signal; and
a hang prevention module for monitoring the data signal such that when the data signal holds a logic LOW or HIGH for a time longer that a predetermined time a reset signal is produced which is applied to said reset input, whereby the producing of data signal by the I2C interface module is reset.

20. A data bus control method for controlling data transmission from, or data receiving to, one terminal connected to a data bus, said terminal having a function to control said data bus through a method comprising:
producing a clock signal by an I2C interface module having a clock output and a reset input;
pulling the data bus to a predetermined level, by a pulling circuit, relatively to the clock signal; and
monitoring the clock signal by a hang prevention module such that when the clock signal holds a logic LOW or HIGH for a time longer that a predetermined time a reset signal is produced which is applied to said reset input, whereby the producing of clock signal by the I2C interface module is reset.

21. A data bus control method for controlling data transmission from, or data receiving to, one terminal connected to a data bus, said terminal having a function to control said data bus through a method comprising:
producing a data signal by an I2C interface module having a data output and a reset input;
pulling the data bus to a predetermined level, by a pulling circuit, relatively to the data signal; and
monitoring the data signal by a hang prevention module such that when the data signal holds a logic LOW or HIGH for a time longer that a predetermined time a reset signal is produced which is applied to said reset input, whereby the producing of data signal by the I2C interface module is reset.
